(19) United States
(12) Patent Application Publication
(10) Pub. No.: US 2019/0121198 A1
(43) Pub. Date: Apr. 25, 2019

(54) DISPLAY DEVICE

(71) Applicant: SHARP KABUSHIKI KAISHA, Sakai City, Osaka (JP)

(72) Inventors: RYOH ARAKI, Sakai City (JP); HIKARU KUKI, Sakai City (JP); TSUYOSHI KAWAGUCHI, Sakai City (JP)

(21) Appl. No.: 16/090,240

(22) PCT Filed: Mar. 22, 2017
(86) PCT No.: PCT/JP2017/011301

§ 371 Date: Sep. 29, 2018

(30) Foreign Application Priority Data
Mar. 29, 2016 (JP) 2016-066395

(51) Int. Cl. G02F 1/1335; G02F 1/13357

(52) U.S. Cl. CPC G02F 1/133555; G02F 1/1336; G02F 2001/133557; G02F 1/133514; G02F 1/133528

(57) ABSTRACT

The present invention provides a display device having an excellent image display function and an excellent mirror function. The display device includes, in the given order from a back surface side to a viewing surface side: a backlight; and a display panel provided with a mirror layer and pixels, the mirror layer being provided with an opening and a reflector superimposed on a corresponding pixel, the opening being provided to allow light emitted from the backlight to pass therethrough to the viewing surface side of the display panel, the reflector being provided to reflect light incident from the viewing surface side of the display panel, the opening having a superimposed area ratio in the corresponding pixel of 10% or higher and 20% or lower.

### TECHNICAL FIELD

The present invention relates to display devices. More specifically, the present invention relates to a display device having an image display function and a mirror function.

### BACKGROUND ART

Patent Literature 1, for example, discloses a mirror display for digital signage or the like applications which includes a half mirror layer on the viewing surface side of a display device and thereby provide a mirror function to the display device. Patent Literature 2, for example, discloses a display device having a mirror function which includes a reflector inside a display device. Such a mirror display and a display device display images and are also used as mirrors by reflecting external light.

### CITATION LIST

### Patent Literature

Patent Literature 1: JP 2006-53277 A
Patent Literature 2: JP 2014-199812 A

### SUMMARY OF INVENTION

### Technical Problem

When the transmittance of a half mirror layer 104 in a conventional mirror display 100 as shown in FIG. 6, for example, is low, display light emerging from a display device 101 is greatly attenuated as it passes through the half mirror layer 104, and thereby the image display function (e.g., luminance) is unfortunately low. In contrast, when the transmittance of the half mirror layer 104 is made high, the reflectance of the half mirror layer 104 is low, and thereby the mirror function is unfortunately low. FIG. 6 is a schematic perspective view of a conventional mirror display.

Meanwhile, in a display device having a reflector, when the area of the reflector is small, i.e., the area of a portion transmitting light is large, the reflectance of the display device is low, and thereby the mirror function is unfortunately low.

Patent Literature 1 discloses a multifunctional image display device. In the multifunctional image display device, the half mirror layer functions as a mirror when display of images by the display device is turned off. The multifunctional image display device functions as an image display device by allowing images behind the half mirror layer to be visible when display of images by the display device is turned on. In the invention disclosed in Patent Literature 1, however, the image display function or the mirror function deteriorates depending on the transmittance of the half mirror layer.

Patent Literature 2 discloses an organic light emitting display device that includes a reflective member including an opening corresponding to the light emission area, and a reflective surface corresponding to the non-light-emission area. In the invention disclosed in Patent Literature 2, however, the reflective member has a low reflectance when the area of the opening is large and the area of the reflective surface is small, and thereby the mirror function is low.

The present invention has been made in view of the above current state of the art, and aims to provide a display device having an excellent image display function and an excellent mirror function.

### Solution to Problem

The present inventors made various studies on display devices having an excellent image display function and an excellent mirror function. The inventors then focused on a configuration in which a mirror layer is assembled into a display device (display panel) and is not a member separate from the display device. The inventors then found that an excellent image display function and an excellent mirror function were achieved using a mirror layer provided with an opening and a reflector superimposed on a corresponding pixel of the display panel. Here, the opening allows light emitted from the backlight to pass therethrough to the viewing surface side of the display panel, and the reflector reflects light incident from the viewing surface side of the display panel. The opening has a superimposed area ratio in the corresponding pixel falling within a predetermined range. The inventors found that such a mirror layer can solve the above problems, arriving at the present invention.

In other words, one aspect of the present invention may be a display device including, in the given order from a back surface side to a viewing surface side: a backlight; and a display panel provided with a mirror layer and pixels, the mirror layer being provided with an opening and a reflector superimposed on a corresponding pixel, the opening being provided to allow light emitted from the backlight to pass therethrough to the viewing surface side of the display panel, the reflector being provided to reflect light incident from the viewing surface side of the display panel, the opening having a superimposed area ratio in the corresponding pixel of 10% or higher and 20% or lower.

### Advantageous Effects of Invention

The present invention can provide a display device having an excellent image display function and an excellent mirror function. The present invention can control the viewing angle characteristics of the display device as desired by varying the viewing angle characteristics of the backlight.

### BRIEF DESCRIPTION OF DRAWINGS

FIG. 1 is a schematic perspective view of a display device of an embodiment.

FIG. 2 is a schematic plan view of a configuration, superimposed on one pixel, of the mirror layer shown in FIG. 1.

FIG. 3 is a schematic cross-sectional view of an exemplary configuration of the reflector shown in FIG. 1.

FIG. 4 is a schematic cross-sectional view of another exemplary configuration of the reflector shown in FIG. 1.

FIG. 5 is a schematic cross-sectional view of an exemplary configuration of the display device of the embodiment.

FIG. 6 is a schematic perspective view of a conventional mirror display.

### DESCRIPTION OF EMBODIMENTS

The present invention is described in more detail below based on an embodiment with reference to the drawings. The embodiment, however, is not intended to limit the scope of the present invention. In the following description, the same members or members having similar functions are provided commonly with the same or similar reference sign between different drawings, and thus description of such a member is appropriately omitted. The configurations in the embodiment may appropriately be combined or modified within the spirit of the present invention.

### Embodiment

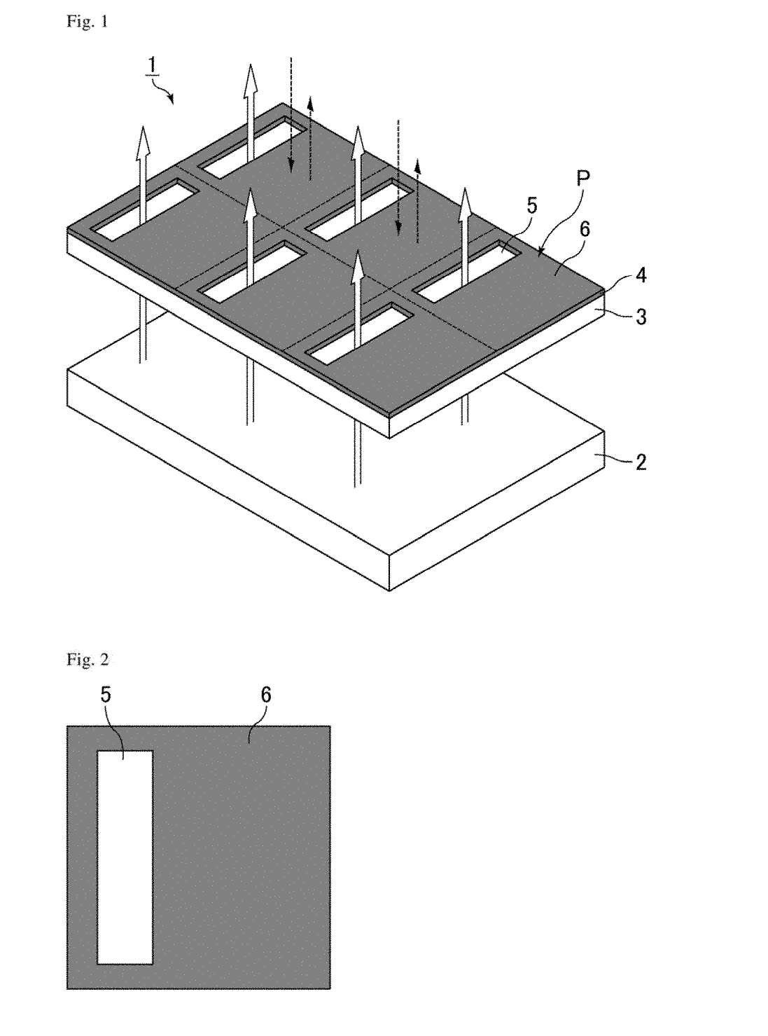

A display device of an embodiment is described below with reference to FIG. 1 and FIG. 2. FIG. 1 is a schematic perspective view of a display device of an embodiment. FIG. 2 is a schematic plan view of a configuration, superimposed on one pixel, of the mirror layer shown in FIG. 1.

A display device 1 includes, in the given order from the back surface side to the viewing surface side, a backlight 2 and a display panel 3. FIG. 1 shows the backlight 2 and the display panel 3 with a space in between, but they may be in contact with each other. The “back surface side” as used herein refers to, for example, the bottom side (backlight 2 side) of the display device 1 in FIG. 1. The “viewing surface side” refers to, for example, the top side (display panel 3 side) of the display device 1 in FIG. 1.

The backlight 2 may be of any type and may be, for example, an edge-lit backlight or a direct-lit backlight. The backlight 2 may utilize any light source such as a light emitting diode (LED) or a cold cathode fluorescent lamp (CCFL).

The display panel 3 is provided with a mirror layer 4 (in FIG. 1, disposed on the viewing surface side of the display panel 3) and pixels P (in FIG. 1, the regions separated by the dotted lines). The mirror layer 4 is provided with an opening 5 and a reflector 6 (portion other than the opening 5) superimposed on the corresponding pixel P. This configuration includes the mirror layer 4 assembled with the display panel 3, with which the parts cost can be easily reduced and the profile of the display device 1 can be easily made thin. In contrast, the conventional mirror display 100 includes the half mirror layer 104 as a member separate from the display device 101 as shown in FIG. 6. This configuration is likely to increase the parts cost and the thickness of the mirror display 100.

The mirror layer 4 may be disposed anywhere in the display panel 3, and may be disposed, for example, on the display surface of the display panel 3 (surface on the viewing surface side) as shown in FIG. 1 or inside the display panel 3.

The openings 5 allow light emitted from the backlight 2 to pass therethrough to the viewing surface side of the display panel 3 as shown by the solid arrows in FIG. 1. Since the openings 5 can allow light incident on the mirror layer 4 to pass therethrough efficiently, the utilization efficiency of display light emerging from the display panel 3 (light emitted from the backlight 2) is high. Thereby, an excellent image display function can be achieved. In contrast, when the transmittance of the half mirror layer 104 is low in the conventional mirror display 100 shown in FIG. 6, display light emerging from the display device 101 is greatly attenuated as it passes through the half mirror layer 104, and thereby the image display function (e.g., luminance) is unfortunately low.

Each opening 5 has a superimposed area ratio in the corresponding pixel (hereinafter, also simply referred to as a superimposed area ratio of each opening) of 10% or higher and 20% or lower. The superimposed area ratio of each opening in the corresponding pixel herein means a ratio of the area of the opening (in FIG. 2, the area of the opening 5) to the area of the mirror layer (in FIG. 2, the sum of the area of the opening 5 and the area of the reflector 6), the opening and the mirror layer being superimposed on the corresponding pixel in a plan view from the viewing surface side. In other words, the superimposed area ratio of each opening in the corresponding pixel represents the aperture ratio of the mirror layer superimposed on the corresponding pixel. Here, for enhancement of the image display function, the superimposed area ratio of each opening 5 is preferably higher. This produces large areas of the openings 5, increasing the transmittance of light incident on the mirror layer 4. In contrast, for enhancement of the mirror function, the superimposed area ratio of each opening 5 is preferably lower. This produces a large area of the reflector 6, increasing the reflectance of the mirror layer 4. Hence, with the superimposed area ratio of each opening 5 falling within the above range, both an excellent image display function and an excellent mirror function can be achieved. Each opening 5 preferably has a superimposed area ratio of 13% or higher and 20% or lower.

Each opening 5 may be a hole or a pore, or may be a light-transmitting portion including a transparent member. For example, the mirror layer 4 may be produced by forming a patterned reflective member on a transparent substrate, so that a configuration with the openings 5 each including a transparent member (transparent substrate) can be achieved.

Each opening 5 may have a quadrangular shape as shown in FIG. 2, for example, or may have a shape other than a quadrangular shape. With square openings 5, isotropic viewing angle characteristics can be achieved in the display surface (x direction and y direction) of the display panel 3. With rectangular openings 5, diffraction occurs and thus anisotropic viewing angle characteristics can be achieved in the display surface of the display panel 3. A shape of the openings 5 suitable for the application (purpose) may therefore be selected.

Each opening 5 preferably has a size equal to or smaller than the resolution of the human eye, for a proper image display function. For example, the long sides of a quadrangular opening 5 are each preferably 0.1 mm or shorter.

The openings 5 may be formed at the positions as shown in FIG. 2 or at any other positions in the respective pixels P on which the openings 5 are superimposed. The positions of the openings 5 may be the same as or different from each other between the pixels P.

One opening 5 may be formed as shown in FIG. 2 or two or more openings 5 may be formed in each pixel P. With two or more openings 5, the superimposed area ratio of the openings 5 is determined based on the sum of the areas of the openings.

The reflector 6 reflects light incident from the viewing surface side of the display panel 3 as shown by the dotted arrows in FIG. 1. The reflector 6 allows a viewer to see light reflected by the reflector 6, and thus can provide a mirror function to the display device 1.

The reflector 6 preferably has a reflectance of 90% or higher and 100% or lower as viewed from the viewing surface side. The reflectance as used herein means a luminous reflectance, unless otherwise specified. The reflectance of the display panel 3 (mirror layer 4) is further increased when the reflectance of the reflector 6 falls within the above range, so that the mirror function can be further enhanced. Specifically, when the superimposed area ratio of each opening 5 and the reflectance of the reflector 6 fall within the respective ranges described above, theoretically, the display panel 3 (mirror layer 4) has a reflectance of 72% or higher. In contrast, the conventional mirror display 100 as shown in FIG. 6 generally has a reflectance as low as 50%. In addition, when the transmittance of the half mirror layer 104 is high, the reflectance of the half mirror layer 104 is low, so that the mirror function is unfortunately even lower.

The reflector 6 preferably includes a specular reflective member such as a metal film (e.g., aluminum (Al), silver (Ag), gold (Au)) or a dielectric multilayer film. At least the surface on the viewing surface side (surface remote from the backlight 2) of the reflector 6 is preferably coated with the specular reflective member described above. Aluminum, silver, and dielectric multilayer film have reflectances of 90%, 93%, and 97%, respectively. Meanwhile, different types of paper, for example, have different reflectances, and thus have different apparent brightnesses under the same level of illumination. For example, a piece of newspaper (reflectance: 50%) appears dark gray while a piece of copy paper (reflectance: 70%) appears bright white. Hence, in order to achieve the reflectance of the display panel 3 (mirror layer 4) of 70% or higher for a high mirror function, for example, aluminum can be used for the reflector 6 if each opening 5 has a superimposed area ratio of about 20%, or a dielectric multiplayer film can be used for the reflector 6 if each opening 5 has a superimposed area ratio of about 10%.

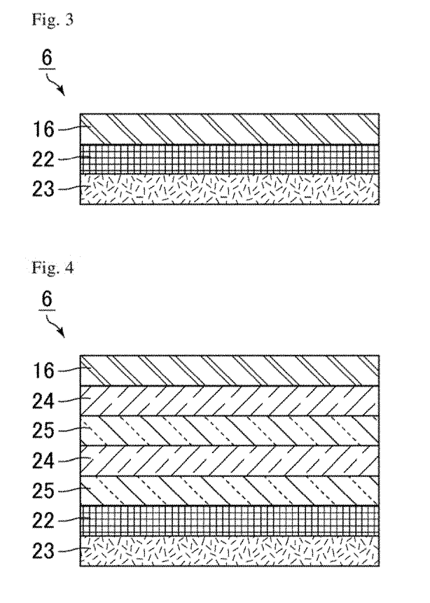

The reflectance of the display panel 3 (mirror layer 4) can be further increased when the reflector 6 includes dielectric films having a high refractive index and dielectric films having a low refractive index alternately stacked. The dielectric films having a high refractive index can be formed of, for example, titanium dioxide (TiO₂), tantalum pentoxide (Ta₂O₅), or niobium pentoxide (Nb₂O₅). The dielectric films having a low refractive index can be formed of, for example, silicon dioxide (SiO₂). For reduction of unnecessary internal reflection in the display panel 3, the reflector 6 preferably includes a low-reflective member as the backmost layer (most adjacent to the backlight 2). This structure can impart the display panel 3 with a high contrast ratio, further enhancing the image display function. The low-reflective member is formed of, for example, molybdenum nitride (MoN). Exemplary configurations of such a reflector 6 are illustrated in FIG. 3 and FIG. 4. FIG. 3 is a schematic cross-sectional view of an exemplary configuration of the reflector shown in FIG. 1. FIG. 4 is a schematic cross-sectional view of another exemplary configuration of the reflector shown in FIG. 1. The following describes the case of forming the mirror layer 4 by forming a film of a constituent material of the reflector 6 (e.g., metal film) on a supporting substrate (e.g., glass substrate), and partially removing the reflector 6 by dry etching, for example, to form the openings 5. In the exemplary configuration shown in FIG. 3, the reflector 6 includes a supporting substrate 16, a metal film 22 (e.g., aluminum), and a low-reflective member 23 stacked in the given order from the viewing surface side to the back surface side. In the exemplary configuration shown in FIG. 4, the reflector 6 includes the supporting substrate 16, a dielectric film having a high refractive index 24, a dielectric film having a low refractive index 25, a dielectric film having a high refractive index 24, a dielectric film having a low refractive index 25, the metal film 22, and the low-reflective member 23 stacked in the given order from the viewing surface side to the back surface side.

The reflector 6 may or may not be colored. A colored reflector 6 enables the display device 1 to be easily integrated with the surrounding environment, i.e., enables the display device 1 to be camouflaged, increasing the designability. For example, the display device 1 with a red colored reflector 6 appears as a red mirror and actually can display images.

The display device of the present embodiment can achieve the following effects.

(1) In the mirror layer 4, the openings 5 are superimposed on the respective pixels P, and thus the utilization efficiency of display light emerging from the display panel 3 (emitted from the backlight 2) is high. Thereby, an excellent image display function can be achieved.

(2) In the mirror layer 4, the reflector 6 (portion other than the openings 5) is superimposed on the corresponding pixel P, so that an excellent mirror function can be achieved.

(3) Each opening 5 has a superimposed area ratio of 10% or higher and 20% or lower, so that the transmittance of light incident on the mirror layer 4 is maintained while the reflectance of the mirror layer 4 is increased. In other words, both an excellent image display function and an excellent mirror function can be achieved.

(4) The viewing angle characteristics of the display device 1 can be controlled as desired by varying the viewing angle characteristics of the backlight 2. In contrast, in a self-luminous display device such as an organic luminescent display device disclosed in Patent Literature 2, the viewing angle characteristics are difficult to control.

(5) The mirror layer 4 is assembled into the display device 1 (the display panel 3) and is not a member separate from the display device 1, with which the parts cost can be easily reduced and the profile of the display device 1 can be easily made thin.

(6) A colored reflector 6 enables the display device 1 to be easily integrated with the surrounding environment, i.e., enables the display device 1 to be camouflaged, increasing the designability.

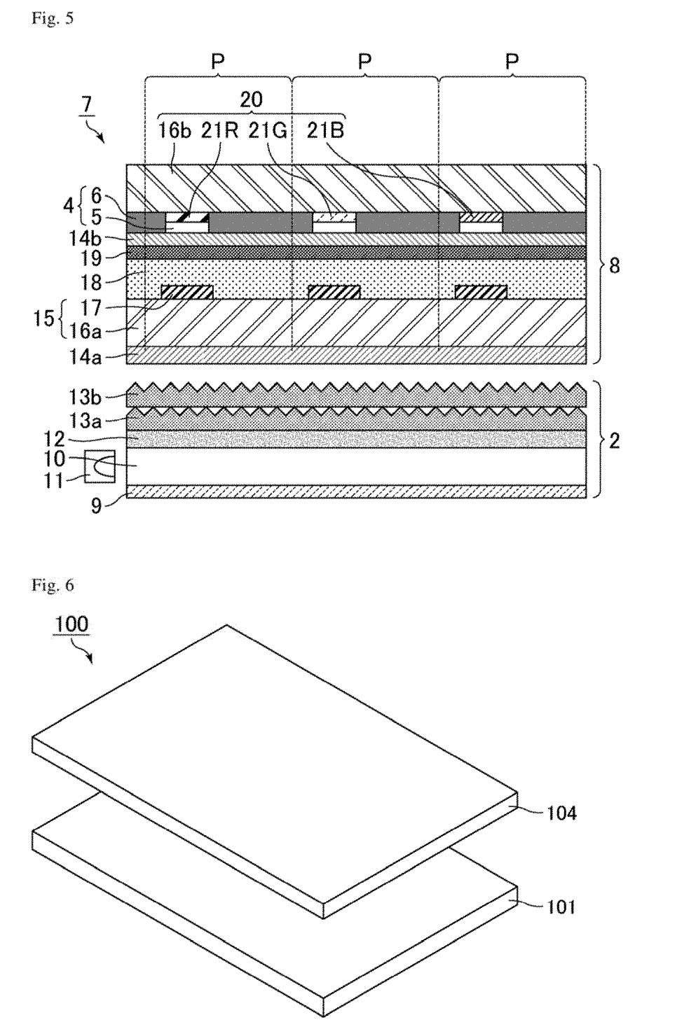

With reference to FIG. 5, an exemplary configuration of the display device 1 is described in which the display panel 3 is a liquid crystal display panel, i.e., the display device 1 is a liquid crystal display device. FIG. 5 is a schematic cross-sectional view of an exemplary configuration of the display device of the embodiment.

A liquid crystal display device 7 includes, in the given order from the back surface side to the viewing surface side, the backlight 2 and a liquid crystal display panel 8.

The backlight 2 includes, in the given order from the back surface side to the viewing surface side, a reflective sheet 9, a light guide plate 10, a diffusion plate 12, a luminance increasing film (prism sheet) 13a, and a luminance increasing film (prism sheet) 13b. Light emitting diodes 11 as the light source are disposed adjacent to an end of the light guide plate 10. In other words, the backlight 2 is an edge-lit backlight. This configuration enables light emitted from the light emitting diodes 11 to travel toward the liquid crystal display panel 8.

The reflective sheet 9 is formed of, for example, a polyester-based resin, silver, or white polyethylene terephthalate (PET). Known examples of a reflective sheet formed of a polyester-based resin include a reflective sheet (trade name: ESR) available from 3M.

The liquid crystal display panel 8 includes, in the given order from the back surface side to the viewing surface side, a polarizer 14a, a thin-film transistor array substrate 15, a liquid crystal layer 18, a common electrode 19, a polarizer 14b, the mirror layer 4, and a color filter substrate 20. The liquid crystal display panel 8 includes the pixels P.

The thin-film transistor array substrate 15 includes a supporting substrate 16a, and pixel electrodes 17 disposed on the surface of the supporting substrate 16a adjacent to the liquid crystal layer 18.

The supporting substrate 16a may be, for example, a transparent substrate such as a glass substrate or a plastic substrate.

The pixel electrodes 17 are formed of, for example, a transparent conductive material such as indium tin oxide (ITO) or indium zinc oxide (IZO).

On the surface of the supporting substrate 16a adjacent to the liquid crystal layer 18 may appropriately be further disposed members such as an alignment film configured to control the alignment of liquid crystal molecules in the liquid crystal layer 18, thin-film transistor elements, and various conductive lines (scanning lines, signal lines). The semiconductor layer in each thin-film transistor element may have any configuration, and may contain, for example, amorphous silicon, low-temperature polysilicon, or an oxide semiconductor. Examples of the oxide semiconductor include a compound composed of indium, gallium, zinc, and oxygen, and a compound composed of indium, zinc, and oxygen. In the case of using as the oxide semiconductor a compound composed of indium, gallium, zinc, and oxygen which has a low off-leakage current, application of voltage to the oxide semiconductor enables paused drive in which the voltage is held until the next data (voltage) is input (applied). A compound composed of indium, gallium, zinc, and oxygen is therefore preferred as the oxide semiconductor in terms of low power consumption.

The color filter substrate 20 includes a supporting substrate 16b and color filter layers 21R (red), 21G (green), and 21B (blue) disposed on the surface of the supporting substrate 16b adjacent to the liquid crystal layer 18. The color filter layers 21R, 21G, and 21B are disposed in the respective openings 5 of the mirror layer 4 in the corresponding pixels P. This configuration allows light emitted from the backlight 2 to pass through the color filter layers 21R, 21G, and 21B as it passes through the openings 5, enabling color display.

The supporting substrate 16b may be, for example, a transparent substrate such as a glass substrate or a plastic substrate.

The combination of colors for color filter layers may be any combination other than the combination of red, green, and blue shown in FIG. 2, such as a combination of red, green, blue, and yellow.

On the surface of the supporting substrate 16b adjacent to the liquid crystal layer 18 may appropriately be further disposed an alignment film configured to control the alignment of liquid crystal molecules in the liquid crystal layer 18, for example.

Although FIG. 5 shows a configuration in which the color filter layers 21R, 21G, and 21B of the color filter substrate 20 are disposed in the respective openings 5, color display can be achieved also by field sequential driving which utilizes light sources of three colors of red, green, and blue for the backlight 2 in place of the color filter layers 21R, 21G, and 21B.

The common electrode 19 may be formed of, for example, a transparent conductive material such as indium tin oxide (ITO) or indium zinc oxide (IZO).

Examples of the polarizers 14a and 14b include absorptive polarizers and reflective polarizers. In a common liquid crystal display panel, polarizers are disposed, one on the surface of the thin-film transistor array substrate remote from the liquid crystal layer, and the other on the surface of the color filter substrate remote from the liquid crystal layer. In the liquid crystal display device 7, however, if disposed on the surface of the color filter substrate 20 remote from the liquid crystal layer 18, the polarizer 14b interferes with the mirror layer 4, and thus the mirror function may deteriorate. Hence, the polarizers (for example, polarizers 14a and 14b) are preferably disposed on the back surface side of the mirror layer 4.

An exemplary configuration of the display device 1 other than the liquid crystal display device may be a configuration utilizing an active matrix substrate having a function of switching between transmission and blocking of light emitted from the backlight. Examples of this configuration include a micro electro mechanical systems (MEMS) shutter display. A MEMS shutter display includes minute shutters in the respective pixels, and turns on/off display of images by opening/closing the shutters to control the transmission amount of light emitted from the backlight. Since a MEMS shutter display does not require members such as a polarizer or a color filter layer, the utilization efficiency of light emitted from the backlight is further increased, and thus power consumption can be reduced. Also, assembling the mirror layer into the MEMS shutter display achieves an excellent image display function and an excellent mirror function.

The present invention is described in more detail below based on examples and comparative examples. The examples, however, are not intended to limit the scope of the present invention.

### EXAMPLE 1

A display device of Example 1 produced was a liquid crystal display device (screen size: 7 inches in diagonal size) as shown in FIG. 5. Each opening 5 had a superimposed area ratio of 10.0%. The reflector 6 included a stack of a dielectric film of niobium oxide and a dielectric film of silicon dioxide. The reflector 6 had a reflectance of 97%.

### EXAMPLE 2

A display device was produced as in Example 1, except that each opening 5 had a superimposed area ratio of 13.4%.

### EXAMPLE 3

A display device was produced as in Example 1, except that each opening 5 had a superimposed area ratio of 20.0%.

### COMPARATIVE EXAMPLE 1

A display device was produced as in Example 1, except that each opening 5 had a superimposed area ratio of 21.0%.

### COMPARATIVE EXAMPLE 2

A display device was produced as in Example 1, except that each opening 5 had a superimposed area ratio of 9.0%.

### Evaluation of Display Device

The image display function and the mirror function of the display devices of Examples 1 to 3 and Comparative Examples 1 and 2 were evaluated. The results are shown in Table 1.

### (Evaluation on Image Display Function)

Five viewers A to E (in Table 1, they are referred to simply as A to E) made sensory evaluations on the appearance (e.g., luminance, contrast ratio, viewing angle) of the display device of each example in the image display mode. The appearance in the image display mode was evaluated by each viewer on a 5-point scale of 1 (the worst appearance), 2, 3, 4, and 5 (the best appearance). The total of their points was taken as the evaluation score (perfect score=25) of the image display function.

### (Evaluation on Mirror Function)

Five viewers A to E (in Table 1, they are referred to simply as A to E) made sensory evaluations on the appearance (e.g., brightness) of the display device of each example in the mirror mode. The appearance in the mirror mode was evaluated by each viewer on a 5-point scale of 1 (the worst appearance), 2, 3, 4, and 5 (the best appearance). The total of their points was taken as the evaluation score (perfect score=25) of the mirror function.

The evaluation score of the image display function and the evaluation score of the mirror function were added, so that the evaluation score (perfect score=50) of the display device of each example was calculated.

TABLE 1

| | Evaluation score | | | | | | Evaluation score | | | | | | Evaluation |
|---|---|---|---|---|---|---|---|---|---|---|---|---|---|
| | (point) of image | | | | | | (point) of mirror | | | | | | score (point) |
| | display function | | | | | | function | | | | | | of display |
| | A | B | C | D | E | Total | A | B | C | D | E | Total | device |
| Example 1 | 4 | 4 | 3 | 3 | 3 | 17 | 5 | 5 | 5 | 5 | 5 | 25 | 42 |
| Example 2 | 5 | 4 | 4 | 3 | 4 | 20 | 5 | 5 | 5 | 5 | 5 | 25 | 45 |
| Example 3 | 5 | 5 | 5 | 5 | 5 | 25 | 3 | 4 | 4 | 4 | 3 | 18 | 43 |
| Comparative | 4 | 5 | 4 | 5 | 4 | 22 | 2 | 3 | 3 | 3 | 3 | 14 | 36 |
| Example 1 | | | | | | | | | | | | | |
| Comparative | 2 | 2 | 2 | 1 | 2 | 9 | 5 | 5 | 5 | 5 | 5 | 25 | 34 |
| Example 2 | | | | | | | | | | | | | |

As shown in Table 1, the evaluation scores of display devices in Examples 1 to 3 were higher than those in Comparative Examples 1 and 2. Since the image display function and the mirror function are in a trade-off relationship with each other, the balance of these functions in Examples 1 to 3 was better than that in Comparative Examples 1 and 2.

### Additional Remarks

The following are examples of preferred features of the display device of the present invention. These examples may appropriately be combined within the spirit of the present invention.

The reflector may have a reflectance of 90% or higher and 100% or lower, as viewed from the viewing surface side. Thereby, the reflectance of the mirror layer is further increased, so that the mirror function can be further enhanced.

The reflector may be colored. Such a reflector enables the display device to be easily integrated with the surrounding environment, i.e., enables the display device to be camouflaged, increasing the designability.

The display panel may be a liquid crystal display panel including a polarizer, and the polarizer may be disposed on the back surface side of the mirror layer. Thereby, even when a liquid crystal display panel is used as the display panel (i.e., when the display device is a liquid crystal display device), the concept of the present invention can be employed in a preferred manner. Also, since the polarizer is disposed on the back surface side of the mirror layer, deterioration of the mirror function can be prevented.

### REFERENCE SIGNS LIST

1, 101: Display device
2: Backlight
3: Display panel
4: Mirror layer
5: Opening
6: Reflector
7: Liquid crystal display device
8: Liquid crystal display panel
9: Reflective sheet
10: Light guide plate
11: Light emitting diode
12: Diffusion plate
13a, 13b: Luminance increasing film (prism sheet)
14a, 14b: Polarizer
15: Thin-film transistor array substrate
16, 16a, 16b: Supporting substrate
17: Pixel electrode
18: Liquid crystal layer
19: Common electrode
20: Color filter substrate
21R, 21G, 21B: Color filter layer 22: Metal film
23: Low-reflective member
24: Dielectric film having high refractive index
25: Dielectric film having low refractive index
100: Mirror display
104: Half mirror layer
P: Pixel

1. A display device comprising, in the given order from a back surface side to a viewing surface side:
a backlight; and
a display panel provided with a mirror layer and pixels,
the mirror layer being provided with an opening and a reflector superimposed on a corresponding pixel,
the opening being provided to allow light emitted from the backlight to pass therethrough to the viewing surface side of the display panel,
the reflector being provided to reflect light incident from the viewing surface side of the display panel,
the opening having a superimposed area ratio in the corresponding pixel of 10% or higher and 20% or lower.

2. The display device according to claim 1,
wherein the reflector has a reflectance of 90% or higher and 100% or lower, as viewed from the viewing surface side.

3. The display device according to claim 1,
wherein the reflector is colored.

4. The display device according to claim 1,
wherein the display panel is a liquid crystal display panel including a polarizer, and
the polarizer is disposed on the back surface side of the mirror layer.
